(19) United States
(12) Patent Application Publication
(10) Pub. No.: US 2026/0163784 A1
(43) Pub. Date: Jun. 11, 2026

(54) NETWORK ALARM CORRELATION SYSTEMS AND METHODS FOR USE IN TELECOMMUNICATION NETWORKS

(71) Applicant: AT&T Intellectual Property I, L.P., Atlanta, GA (US)

(72) Inventors: James Oliver, Wilsonville, AL (US); Chaoxin Qiu, Austin, TX (US)

(73) Assignee: AT&T Intellectual Property I, L.P., Atlanta, GA (US)

(21) Appl. No.: 18/975,005

(22) Filed: Dec. 10, 2024

(51) Int. Cl. H04L 41/0631

(52) U.S. Cl. CPC H04L 41/0631

(57) ABSTRACT

Aspects of the subject disclosure may include, for example, detecting, by a processing system including a processor, a set of alarms from a plurality of network element types, wherein the plurality of network element types are interconnected via a particular topology and deployed in a communication network; retrieving, by the processing system, each service group tag of the set of alarms, wherein a service group tag identifies two or more of the plurality of network element types that belong to a same service group; determining, by the processing system, an alarm classification associated with the retrieved service group tag for each of the set of alarms; identifying, by the processing system, a root cause alarm node based on the determined alarm classification; and generating, by the processing system, a fault correction ticket for the identified root cause alarm node. Other embodiments are disclosed.

### FIELD OF THE DISCLOSURE

The subject disclosure relates to network alarm correlation systems and methods for use in telecommunication networks.

### BACKGROUND

In managing a telecommunications network, one of the tasks is resolving alarm conditions. Because of interconnection and possible dependencies between discreet network elements, an alarm issued by one element may be related to alarms issued by other elements. Resolving the alarm condition more efficiently may require identifying a root cause alarm and associating related alarms to it so that more focus can be applied to resolving the root cause alarm. This may also lead to resolving related alarms. A challenge to be solved can be how to systematically determine the root cause alarm and associate or correlate the related alarms to the root cause alarm consistently.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B illustrates an example, non-limiting embodiment of operations of the system of FIG. 2A in accordance with various aspects described herein.

FIG. 2C depicts a first illustrative embodiment of determining a correlation and a root cause of network alarms in accordance with various aspects described herein.

FIG. 2D depicts a second illustrative embodiment of determining a correlation and a root cause of network alarms in accordance with various aspects described herein.

FIG. 2E depicts a third illustrative embodiment of determining a correlation and a root cause of network alarms in accordance with various aspects described herein.

FIG. 2F depicts a fourth illustrative embodiment of determining a correlation and a root cause of network alarms in accordance with various aspects described herein.

FIG. 2G depicts a fifth illustrative embodiment of determining a correlation and a root cause of network alarms in accordance with various aspects described herein.

FIG. 2H depicts an illustrative embodiment of a method in accordance with various aspects described herein.

FIG. 2I depicts an illustrative embodiment of another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for network alarm correlation systems and methods for use in telecommunication networks. The network alarm correlation systems and methods are configured to determine a root cause and resolve alarm correlation need at least by defining relationships among interconnected/interdependent network element types. Based on the defined relationships, it is determined which alarms from those element types make up an alarm signature that can reliably guide a root cause determination and alarm correlation. The alarm signature is stored in an alarm signatures database. The network alarm correlation systems and methods are configured to generate element-level relationships and determine alarm signature as well as performing the root cause determination and alarm correlation. Other embodiments are described in the subject disclosure.

One or more aspects of the subject disclosure include are directed to a device including a processing system having a processor and a memory that stores executable instructions that, when executed by the processing system, facilitate performance of operations. The operations include determining a topology of a group of network elements deployed in a communication network, wherein the network elements correspond to interconnected nodes within the group and have different network element types; determining a relationship group associated with two or more of network element types at least based on the topology of the network elements and predetermined criteria; establishing an alarm management database structured to correlate each alarm with each relationship group to which a network element type of each alarm belongs, via a relationship group tag and an alarm classification, wherein the alarm classification represents a hierarchical alarm level of each alarm in each relationship group correlated by the relationship group tag; detecting a set of alarms for the group of network elements; based on the correlated relationship group tag and the hierarchical alarm level, identifying one or more root cause nodes of the set of alarms, wherein the set of alarms has been originated from the one or more root cause nodes of the set of alarms; and generating a fault correction ticket targeting the one or more root cause nodes of the set of alarms.

One or more aspects of the subject disclosure are directed to a non-transitory machine-readable medium, comprising executable instructions that, when executed by a processing system including a processor, facilitate performance of operations. The operations include maintaining a service group database structured to store a service group tag indicating a relationship group of two or more network element types; maintaining an alarm definition database structured to store a plurality of different alarm definitions resulting from each network element type in a form of an alarm key, wherein a unique alarm key identifies each alarm in the plurality of different alarm definitions; maintaining an alarm management database structured to link each alarm with each relationship group to which a network element type of each alarm belongs, via the service group tag and an alarm classification, wherein the alarm classification represents a hierarchical alarm level of each alarm in each relationship group linked by the service group tag; receiving a set of alarms resulting from a target group having different network element types interconnected via a particular topology within the target group, wherein the set of alarms is generated sequentially or simultaneously; executing an alarm manager to determine a root cause node of the set of alarms using the service group tag and the alarm classification of each alarm in the alarm management database within the target group; and generating a ticket responsive to the determined root cause node of the set of alarms.

One or more aspects of the subject disclosure are directed to a method including detecting, by a processing system including a processor, a set of alarms from a plurality of network element types, wherein the plurality of network element types are interconnected via a particular topology and deployed in a communication network; retrieving, by the processing system, each service group tag of the set of alarms, wherein a service group tag identifies two or more of the plurality of network element types that belong to a same service group; determining, by the processing system, an alarm classification associated with the retrieved service group tag for each of the set of alarms; identifying, by the processing system, a root cause alarm node based on the determined alarm classification; and generating, by the processing system, a fault correction ticket for the identified root cause alarm node.

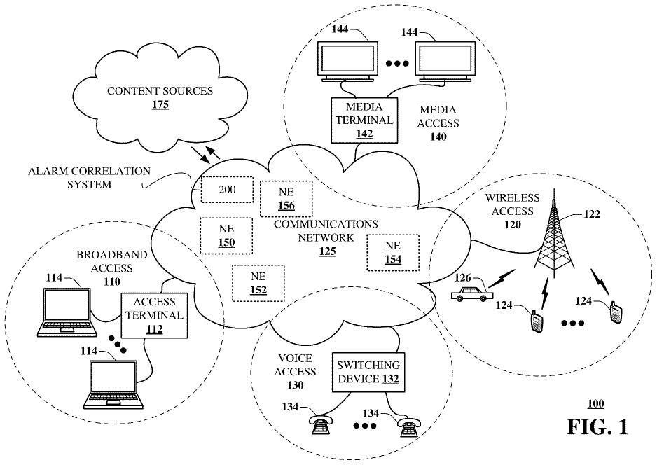

Referring now to FIG. 1, a block diagram is shown illustrating an example, non-limiting embodiment of a system 100 in accordance with various aspects described herein. For example, system 100 can facilitate in whole or in part network alarm correlation systems and methods for use in communication networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

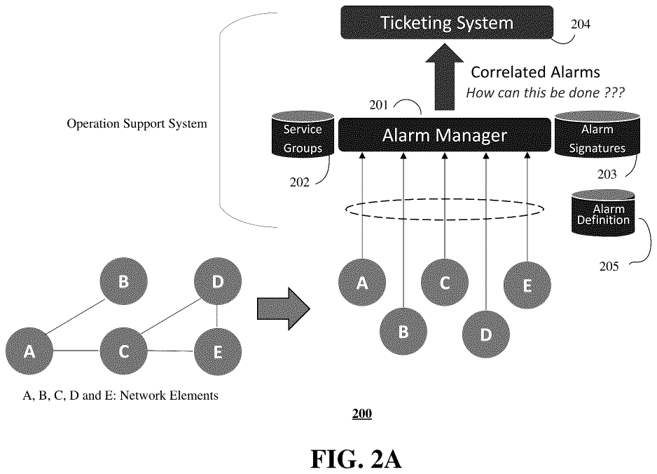

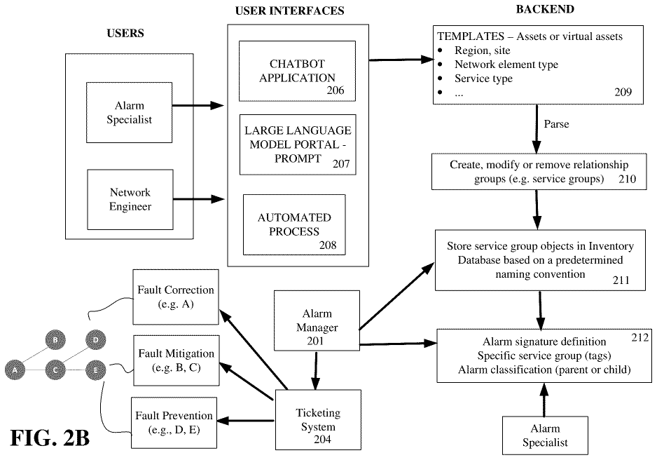

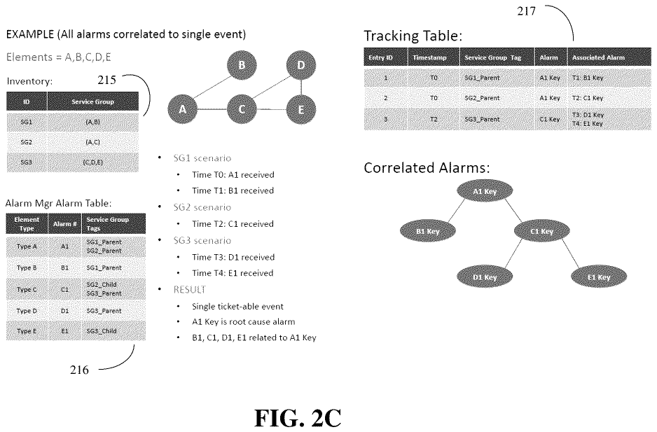

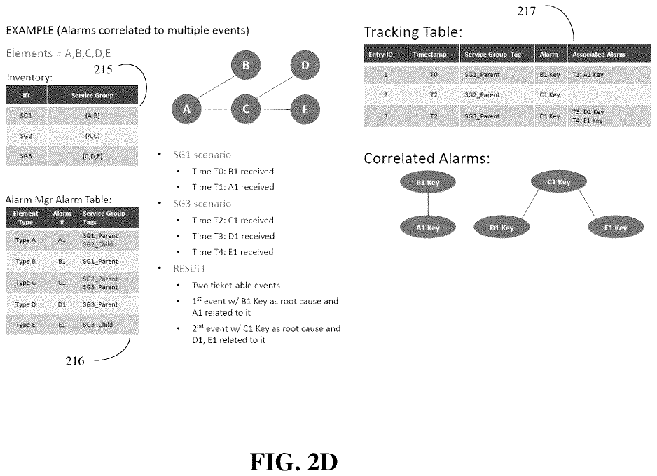

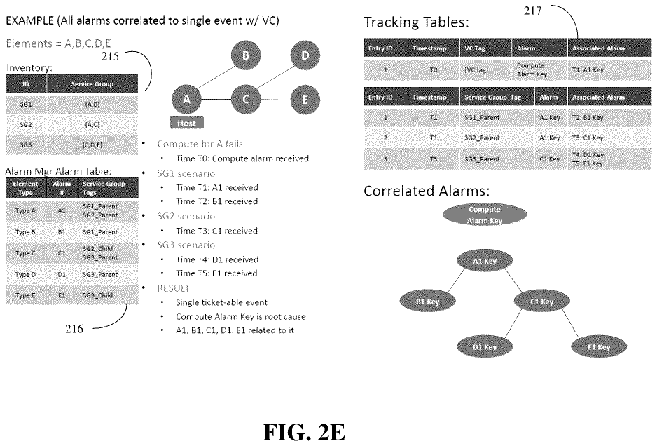

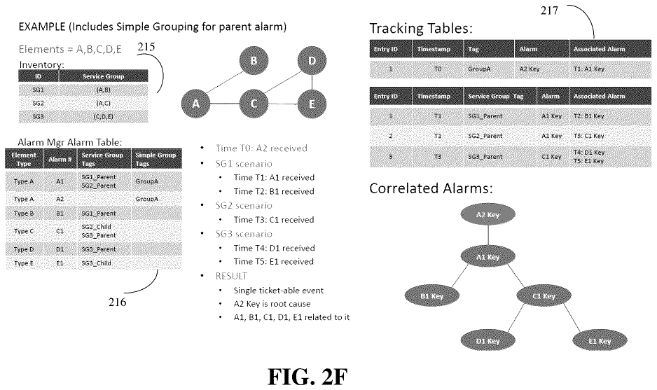

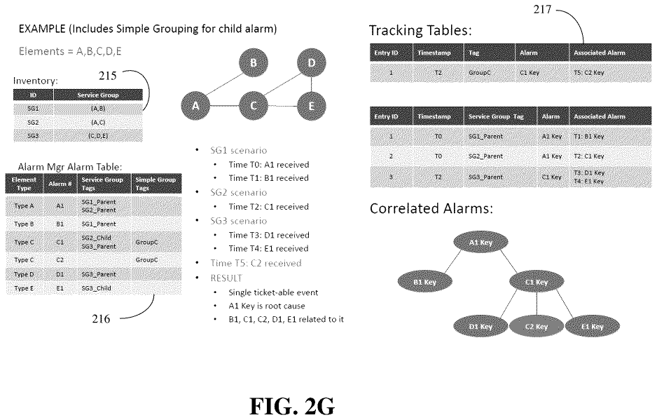

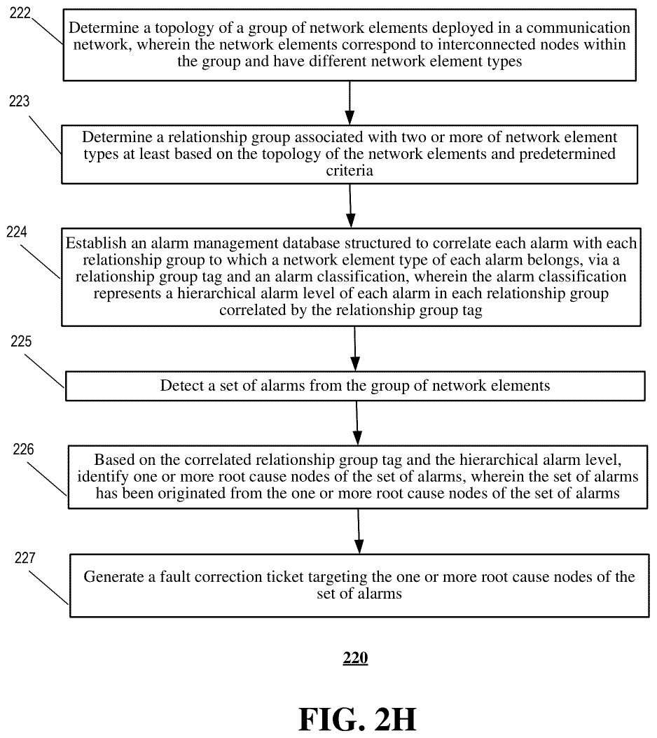

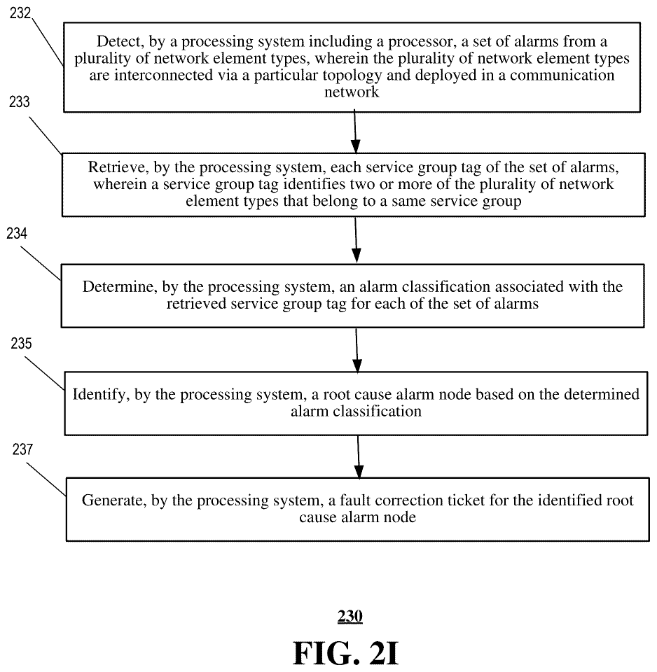

FIG. 2A is a block diagram illustrating an example, non-limiting embodiment of a system 200 functioning within the communication network of FIG. 1 in accordance with various aspects described herein. In various embodiments, the system 200 includes an alarm manager 201, a service groups database 202, an alarm signatures database 203, a ticketing system 204, and an alarm definition database 205. The system 200 is configured to receive, detect, and process alarms from various network elements including A, B, C, D and E deployed in communication networks.

In various embodiments, the system 200 is implemented in an operation support system (OSS). The OSS manages, monitors, controls and analyzes communication networks and support management functions such as network inventory, service provisioning, network configuration and fault management. With respect to the fault management, the OSS monitors and processes network alarms coming from network elements, such as switches, routers, gateways, etc. The OSS provides real-time network alarms and historical data. The OSS can classify alarms by severity, category, and color, and acknowledge, suppress, and filter alarms.

In various embodiments, in managing telecommunications networks, one of tasks is resolving alarm conditions. Because of interconnection and possible dependencies between discreet network elements, an alarm issued by one element may be related to alarms issued by other elements. To resolve the alarm condition more efficiently, it may require identifying a root cause alarm and associating related alarms to the root cause alarm so that more focus can be applied to resolving the root cause alarm. This may also lead to resolving the related alarms. A challenge to be addressed and solved is how to systematically determine the root cause alarm and associate (i.e. correlate) the related alarms to the root cause alarm in an accurate manner.

In various embodiments, a set of network elements is deployed with various interconnections. As depicted in FIG. 2A, network elements A, B, C, D and E, are interconnected to form a certain topology. These network elements send alarms to the alarm manager 201 for identifying a problem to be resolved. Some alarms are related to stand-alone failure conditions. Some alarms are related to alarms issued by other network elements in the network. It is important and advantageous to determine automatically the problems associated with network elements during alarm processing.

In various embodiments, the system 200 is configured to determine a root cause and resolve alarm correlation need at least by defining relationships between the interconnected/interdependent network element types. Based on those relationships, it is determined and declared which alarms from those element types make up an alarm signature that can reliably guide the root cause determination and alarm correlation. The alarm signature is stored in the alarm signatures database 203. The system 200 is configured to generate element-level relationships among the interconnected network elements and declare the alarm signature as well as algorithm for performing the root cause determination and alarm correlation.

In various embodiments, network element deployment models can be considered for defining the element-level relationships. A deployment model would include multiple element instances of varying types, by way of one example only, a virtual IP Multimedia Core Network Subsystem (IMS) core (with Proxy Call Session Control Function (P-CSCF), S/I-CSCF, Telephony Application Server (TAS), Home Subscriber Server (HSS)). The S-CSCF is the primary node in the IMS responsible for session control. Subscribers will be allocated to the S-CSCF for the duration of their IMS registration in order to facilitate routing of Session Initiation Protocol (SIP) messages as part of service establishment procedures. The TAS provides service logic for invoking the media servers to support appropriate call progress tones and announcements in various stages of call.

The above instances of the IMS server are deployed simultaneously or in sequence as part of a single installation event. This deployment model in essence can serve as a process for defining a group of elements with an interconnection/interdependent relationship. From there, the alarm signature definition is still required, and a process used for defining that alarm signature is not available, except through building use case specific logic. Building the use case specific logic typically requires costly development and fine tuning as signatures are consistently required, as platforms are upgraded to future releases, or as different implementations are deployed to provide additional services. Moreover, mandating a “deploy as a group” approach may or may not happen in actual deployment implementation depending on network operator's deployment plans. Mandating the “deploy as a group” approach may need to potentially develop an extensive logic tree to handle numerous alarm signature use cases that will evolve over time.

The system 200 is configured to determine root cause and resolving the alarm correlation need. The system 200 is configured to define relationships between the interconnected/interdependent network element types, and then based on those relationships declare which alarms from those element types make up an alarm signature that can reliably guide the root cause determination and alarm correlation. The system 200 includes an approach for generating the element-level relationships and declaring the alarm signature as well as the algorithm for performing the root cause determination and alarm correlation. The system 200 is described in the context of alarm processing in a telecommunications or computer network of interconnected elements, but the present disclosure is not limited thereto. The present disclosure can be applied more generally to other forms of data from a set of related elements where there are relationships that can be defined at the element and data levels. As one example, another use case is for correlating performance data across multiple elements, e.g. to determine a root cause of performance issue(s).

FIG. 2B illustrates an example, non-limiting embodiment of operations of the system 200 in accordance with various aspects described herein. In various embodiments, network elements A, B, C, D and E are described by way of example only. As depicted in FIG. 2B, a topology of and among the network elements A, B, C, D and E is first determined. The topology among the network elements is determined based on operations, arrangements, connections, functions, etc. of the network elements in a communication network where the network elements are deployed. As depicted in FIG. 2B, users such as an alarm specialist, a network engineer, etc. provide inputs relating to the topology of the network elements via user interfaces. For instance, a chatbot application 206 can be used to interact with users or guide users to determine the topology of the network elements. Additionally, or alternatively, artificial network/machine learning (AI/ML) techniques can be used to determine the topology among the network elements. For instance, users may use a generative artificial intelligence such as a large language model (LLM) portal 207 that operates based on a prompt from users. A generative artificial intelligence engine receives the prompt and returns the determined topology to users or a backend system. An automated process 208 is running on the user interfaces to monitor or track updates or changes to the network elements which may or may not affect the topology.

In various embodiments, once the topology among the network elements is determined, an element-level relationship definition is established in the form of service groups. A service group contains multiple element instances of varying types. The creation of the service groups is facilitated via constructed templates 209 that are used to provide criteria for automatically constructing the service groups from element instances stored in an inventory database. The template criteria can include designation of geographical region or site, element type, service type, etc. As depicted in FIG. 2B, users may provide input relating to the template criteria via user interfaces and/or the automated process 208 may collect and provide information relating to the template criteria.

In various embodiments, templates 209 can be implemented in various formats, e.g. JSON or XML format, which is parsed by a process that creates relationship groups. By way of example, relationship groups are referred to as service groups (at 210). As described above, such templates may be created by creating the template files directly by users or via the user interface. A service group creation process parses the templates 209 and creates service group objects that can be stored, e.g. in the inventory database (at 211). Service group naming should follow a convention that identifies the scope of the service group, e.g. [region(s)]_[site(s)]_[types]_[service supported]. The processes (at 210, 211) associate inventoried physical and/or virtual assets to a service group object based on the criteria defined in the template 209. With the template(s) defined, an automated mechanism, for instance, using AI/ML techniques, can query the inventory database for element instances that match the criteria and build the service group(s). Individual service groups can also be stored in the inventory database to be made available for querying during alarm processing.

In various embodiments, service groups can be modified or moved. Creation/modification occurs periodically to ensure that service groups have the latest set of member element instances. Modifying the template 209 for a given service group results in change of members in the service group. Removal from the template 209 for a given service group results in deletion of the service group object. Retrieval of service groups from the inventory database identifies members of the service group. Service groups can be associated with or assigned to network elements in a form of tags (at 212). Each service group tag identifies a specific service group, alarm classification, e.g., a parent alarm or a child alarm, etc. (at 212). Assignment of the service group tag may be performed by users, or using an AI/ML driven automated process to assign and update assignments over time. Assignment of multiple service group tags is allowed to an alarm.

In various embodiments, a service group associated with a network element is represented by using a service group tag (at 212). Using the service group tag, the alarm signature definition is established (at 212). The alarm signature definition relies on applying service group tags to each of the relevant alarms for an element type (at 212). Each element type has the alarm definition database 205 (shown in FIG. 2A) that includes a listing of all alarms that may be issued from that element type. For instance, a call session control function (CSCF) element has a list of 100 different alarms that can be issued from that element, which is stored in the alarm dictionary for the CSCF element. Each alarm is assigned with an alarm identifier as an alarm key. By way of example only, 3 CSCF elements have 100 different alarms associated with these 3 CSCF elements and alarms can be designated and identified with the element name and the alarm key as follows:
[Element name]_[Alarm Key]
   CSCF01_#001, CSCF_#002, . . . CSCF_#100
   CSCF02_#101, CSCF_#102, . . . CSCF_#200
   CSCF03_#201, CSCF_#202, . . . CSCF_ 190 300
      Accordingly, each alarm key is unique and distinctive from other alarm keys which enables each different alarm to be recognized by the system 200.

In various embodiments, the element type specific alarm dictionary is known and used by an alarm manager (e.g., the alarm manager 201 in FIG. 2A), which is responsible for receiving and processing alarms, and that dictionary is typically stored in a database such as the alarm definition database 205 (e.g., the alarm dictionary) for querying purposes.

In various embodiments, the assignment of service group tags facilitates alarm signature definition 212. As described above, the service group tags are added to the alarm definition stored and used in the alarm processing and correlating the alarms by the alarm manager 201. Individual alarms in the alarm dictionary stored are updated with service group tags to identify parent/child alarms for a group. The assignment of the service group tags can be performed by users or as automated activities based on analysis of the received alarms from members of a group to be affecting alarm conditions of the group. Removal of the service group tags can also be done by users or as the automated activity (e.g. when a service group is removed from the inventory database).

In various embodiments, a list of applicable service group tags may be assigned to each of the alarms in the dictionary and stored in an alarm manager database. The assignment of a service group tag for a particular service group to individual alarms of network elements in that service group creates the definition of an alarm signature. Those assigned with service group tags can then queried during alarm processing to determine if a received alarm belongs to a known service group and facilitates correlation with other alarms received from network elements in the same service group.

In various embodiments, using the alarm signature facilitates systematically defining element-level relationships, independent of how or when network elements are deployed as well as the ability to build the alarm signature definitions for those relationships via configuration, instead of use case specific logic. Both of these aspects allow for the horizontal correlation capability to be grown and fine-tuning via a configuration-based process, reducing the amount and the need of costly logic development. A significant benefit may be in the reduction of operator investigation and analysis to identify and resolve a problem in the network. With a need to become more efficient in the operation of telecommunication networks, it is possible to directly address the need for quicker identification and resolution, thus supporting a desire to reduce overall operational cost.

In various embodiments, element level relationship groups including 2 or more assets are created. A relationship definition is created to serve as a template for a relationship group. As described above, the template 209 in FIG. 2B contains criteria for determining what elements are included in the service group, e.g. region/location, element type, service type, etc. Creation of relationship groups should be dynamic and guided by relationship definition. Relationship definitions may be modified which will impact relationship groups. Modifying relationship definitions may be performed via template changes and should avoid changing the logic in place. Element instances can exist in multiple relationship groups. Alarms issued may effect more than one relationship group.

In various embodiments, alarm level relationship per element type within a relationship group (i.e., alarm signature definition) is created. The alarm level relationship per element type may be referred to as alarm classification. Creation/modification of alarm relationships must be performed via configuration changes and should avoid need for logic changes. Modifying alarm relationships will impact future horizontal correlation. Alarm relationship granularity is required. More specifically, alarms are identified to indicate anchor/parent alarms for a relationship group, which serve as base alarms for correlation within the relationship group. Alarms are identified to be related to the anchor alarms within a relationship group but are not anchor alarms themselves, as child alarms. An alarm is classified as only a child alarm means the alarm can be associated to a parent alarm. However, if a parent alarm is not available, then that alarm can be standalone. It is important to note that not all alarms from elements in the group are related to a parent alarm. Alarms may be treated as a parent alarm and a child alarm within a relationship group based on the relationship definition. In other words, alarms can be a parent alarm for one group and a child alarm for another.

In various embodiments, alarm correlation in action operates as follows. A parent alarm for an element within a service group is received for a group affecting alarm condition. A new entry in the service group parent alarm is added to a tracking table if one does not already exist. If one already exists, then the received alarm is treated as a child alarm and associated to the pre-existent parent alarm. One or more alarms from network elements in the service group may be received for the same condition. To determine if an alarm is a child alarm or not, each alarm is inspected for service group tags that match current service group tags in the tracking table. When a match is found, that alarm is associated with the parent alarm as a child alarm. If multiple matches found, the child alarm is associated with a first entered parent alarm. If no match is found, then the child alarm is treated as a standalone alarm. The parent/child correlation can also be performed with vertical correlation or simple grouping related correlation (e.g. grouping of alarms from the same instance). If a vertical correlation relationship is determined for a tracked parent alarm, then the parent and associated child alarms are associated with the vertical correlation anchor alarm. If a parent or child alarm is part of a simple grouping relationship, then the non-parent/child alarms associated in the simple grouping can also be included in the horizontal correlation.

In various embodiments, the alarm manager 201 (in FIG. 2B), upon detecting an alarm, accesses the inventory database, the alarm signature definition database, and the alarm definition database and processes the alarm based on the service group tag, the alarm key, and the alarm classification (parent or child, or standalone). After processing and analyzing the alarm, the alarm manager 201 sends information to the ticketing system 204. The ticketing system 204 may take a fault correction action for a network element having a root cause (e.g., network element “A”), a fault mitigation action for network element(s) interconnected to the root cause element (e.g., network elements, “B”, “C”), and/or a fault prevention action for network element(s) related via another network element to the root cause element (e.g., network elements, “D”, “E”).

FIG. 2C depicts a first illustrative embodiment of determining a correlation and a root cause of network alarms in accordance with various aspects described herein. By way of example only, network elements A, B, C, D and E are deployed in the telecommunication network and form particular topology among them. As depicted in FIG. 2C, an inventory database 215 includes service groups, SG1, SG2 and SG3 by way of example only, and each service group is associated with a group of network elements, such as SG1—(A, B), SG2—(A, C), and SG3 (C, D, E), by way of example only. As depicted in FIG. 2C, the alarm management database 216 defines an element type, an alarm number (e.g., a unique number within the alarm dictionary for the associated alarm type), and service group tags. Moreover, alarm classification such as a parent or child alarm is also indicated with respect to each alarm number within a network element type for alarms that may be triggered by conditions that occur within a defined service group. For instance, alarm number A1 is a part of the alarm dictionary for network element type A and has been associated with two service groups, SG1 and SG2, and designated as SG1_parent and SG2_parent. Alarm number “C1,” is a part of the alarm dictionary for network element Type C and is designated as SG2_Child and SG3_Parent. This means that the alarm number, C1, is considered and treated as a child alarm to “A1” for elements that belong to the service group, SG2. The alarm number, C1, is also a parent alarm to alarm numbers, “D1” and “E1” for elements that belong to service group SG3.

In various embodiments, an alarm tracking table 217 tracks an occurrence of an alarm and logs the occurrence of the alarm with a timestamp, a service group tag, an alarm identifier/key that is globally unique across all received alarms from all monitored network elements, and the alarm key of alarm(s) associated with the logged alarm based on the defined service group relationship. As depicted in FIG. 2C, a first exemplary alarm event takes places where at Time T0, the A1 alarm is received from a network element instance of Type A, at Time T1, the B1 alarm is received from a network element instance of Type B, at Time T2, the C1 alarm is received from a network element instance of Type C, at Time T3, the D1 alarm is received from a network element instance of Type D, and the E1 alarm is received from a network element instance of Type E. The alarm manager processes the first exemplary alarm event by accessing relevant information from the inventory database 215, the alarm management database 216, and the tracking table 217. The alarm management database 216 indicates that in the service groups SG1 and SG2, the A1 alarm is a parent alarm to the B1 alarm and the C1 alarm when received prior to the B1 alarm. Similarly, the alarm management database 216 indicates that in the service group SG3, the C1 alarm is a parent alarm to the D1 alarm and the E1 alarm. These relationship groups and the timing of the alarms indicate that the A1 alarm is a root cause node of the alarm.

As described above, each instance of the A1 alarm from a network element in Type A is identified by using a different key that is globally unique. The same implementation applies to other alarms, B1, C1, D1 and E1 from network elements in Type B, Type C, Type D and Type E. As a result, the first exemplary alarm event yield a single ticketable event. This is a result from the receipt of the A1 alarm, which is identified as the A1 key from Type A network element that is part of the service groups, SG1 and SG2 followed by alarms, the B1, C1, D1 and E1 alarms from their respective network elements in the service groups SG1, SG2, and SG3. The hierarchical arrangement depicted in FIG. 2C illustrates the relationship that is determined, showing the A1 alarm (with the A1 key) as the root cause alarm for the B1 alarm (i.e., B1 key), the C1 alarm (i.e., C1 key), the D1 alarm (i.e., the D1 key), and the E1 alarm (i.e., E1 key).

In various embodiments, the ticketing system 204 (shown in FIG. 2A) issues a single ticket for a fault correction action with respect to the A1 alarm (A1 key) from a Type A network element in service groups SG1 and SG2 and for the rest of the alarms (i.e., the B1, C1, D1 and E1 alarms: B1 key, C1 key, D1 key and E1 key, respectively) in the service groups SG1, SG2 and SG3, a fault mitigation action and/or a fault prevention action will be taken. That single ticket with the A1 alarm (A1 key) as the root cause alarm will be sent to network maintenance technicians.

FIG. 2D depicts a second illustrative embodiment of determining a correlation and a root cause of network alarms in accordance with various aspects described herein. As depicted in FIG. 2D, a second exemplary alarm event takes places where at Time T0, a B1 alarm is received, at Time T1, an A1 alarm is received, at Time T2, a C1 alarm is received, at Time T3, a D1 alarm is received, and an E1 alarm is received. As described above in connection with FIG. 2C, the A1 alarm, the B1 alarm, the C1 alarm, the D1 alarm and the E1 alarm are part of the alarm dictionary for network element types A, B, C, D and E and have been associated with different service groups (e.g., the A1 alarm: SG1, SG2, the B1 alarm: SG1, the C1 alarm: SG2, SG3, etc.). For instance, the B1 alarm is considered and treated as a parent alarm to the A1 alarm for elements that belong to the service group SG1, and the C1 alarm is considered and treated as a parent alarm to the A1 alarm for elements that belongs to the service group SG2.

In various embodiments, the alarm tracking table 217 tracks an occurrence of an alarm and logs the occurrence of the alarm with a timestamp, a service group tag, an alarm identifier/key that is globally unique across all received alarms from all monitored network elements, and the alarm key of alarm(s) associated with the logged alarm based on the defined service group relationship. The alarm manager processes the second exemplary alarm event by accessing relevant information from the inventory database 215, the alarm management database 216, and the tracking table 217. The alarm management database 216 indicates that in the service groups SG1 and SG2, the A1 alarm is a child alarm to the B1 alarm when received later than the B1 alarm and also can be a child alarm to the C1 alarm. Similarly, the C1 alarm is a parent alarm to the A1 alarm in the service group SG2 and the parent alarm to D1 and E1 alarms in the service group SG3. These relationship groups and the timing of the alarms indicate that B1 is a root cause node of the A1 alarm, and the C1 alarm is a root cause node of the alarm D1 and E1. As a result, the second exemplary alarm event yields two ticketable events. This is a result from the receipt of the B1 alarm (i.e., B1 key) from a Type B network element that is part of SG1 followed by the A1 alarm, and a result from the receipt of the C1 alarm (i.e., C1 key) from a Type C network element that is part of SG3 followed by the D1 and E1 alarms. The hierarchical arrangement depicted in FIG. 2D illustrates the relationship that is determined, showing the B1 alarm (with the B1 key) as the root cause alarm for the A1 alarm (A1 key) and the C1 alarm (with the C1 key) as the root cause alarm for the D1 and the E1 alarms (D1 key and E1 key, respectively).

In various embodiments, the ticketing system 204 (FIG. 2A) issues two tickets for a fault correction action with respect to the B1 alarm from a Type B network element in service group SG1 and the C1 alarm from a Type C network element in service groups SG2 and SG3 and a fault mitigation action and/or a fault prevention action will be taken with respect to the A1, the D1 and the E1 alarms. Those two tickets with the B1 alarm (B1 key) and the C1 alarm (C1 key) as the root cause alarms will be sent to network maintenance technicians.

FIG. 2E depicts a third illustrative embodiment of determining a correlation and a root cause of network alarms in accordance with various aspects described herein. As depicted in FIG. 2E, a third exemplary alarm event takes places where at Time T0, a compute alarm is received, at Time T1, an A1 alarm is received, at Time T2, a B1 alarm is received, at Time T3, a C1 alarm is received, at Time T4, a D1 alarm is received, and at Time T5, an E1 alarm is received. The C1 alarm is considered and treated as a child alarm to the A1 alarm for elements that belong to service group SG2. The C1 alarm is also considered and treated as a parent alarm to the alarms D1 and E1 for elements that belong to service group SG3. The A1 alarm is considered and treated as a parent alarm to the B1 alarm for elements that belong to service group SG1 when received prior to the B1 alarm. These relationship groups and the timing of the alarms indicate that the compute alarm is a root cause alarm and the A1, B1, C1, D1 and E1 alarms have resulted from the compute alarm. As a result, the third exemplary alarm event yields a single ticketable event. This is a result from the receipt of the compute alarm, followed by the A1, B1, C1, D1 and E1 alarms from their respective network elements in service groups SG1, SG2 and SG3. The hierarchical arrangement depicted in FIG. 2E illustrates the relationship that is determined, showing the compute alarm (with a computer alarm key) as the root cause alarm for the A1, the B1, the C1, the D1 and the E1 alarms.

In various embodiments, the ticketing system 204 issues a ticket for a fault correction action with respect to a compute system of a cloud and for the rest of alarms (i.e., the A1, the B1, the C1, the D1 and the E1 alarms in services groups SG1, SG2, and SG3), a fault mitigation action and/or a fault prevention action will be taken. The single ticket with the compute alarm as the root cause alarm will be sent to a cloud service provider and/or network maintenance technicians.

FIG. 2F depicts a fourth illustrative embodiment of determining a correlation and a root cause of network alarms in accordance with various aspects described herein. As depicted in FIG. 2D, a fourth exemplary alarm event takes places where at Time T0, an A2 alarm is received, at Time T1, an A1 alarm is received, at Time T2, a B1 alarm is received, at Time T3, a C1 alarm is received, at Time T4, a D1 alarm is received, and at Time T5, an E1 alarm is received. As depicted in FIG. 2F, the alarm management database 216 does not indicate a service group tag for the A2 alarm. Instead, the alarm management database 216 indicates a simple group tag for the A2 alarm, which is Group A along with the A1 alarm. The A1 alarm is part of the alarm dictionary for network element type A and has been associated with two service groups, SG1 and SG2. The fourth exemplary alarm event encompasses the situation where the alarm A2 is considered and treated as Group A along with the alarm A1, both of which the alarms A1 and A2 may be triggered by conditions that occur within a defined service group of Group A.

The alarm manager processes the fourth exemplary alarm event by accessing relevant information from the inventory database 215, the alarm management database 216, and the tracking table 217. The alarm management database 216 indicates the simple group tag linking the alarms A1 and A2 that belong to Group A. In addition, in the service group SG2, the A1 alarm is a parent alarm to the C1 alarm, which is a parent alarm to the D1 and E1 alarms in the service group SG3. Similarly, in the service groups, SG1 and SG2, the A1 alarm is a parent alarm to the B1 alarm when received prior to the B1 alarm. These relationship groups and the timing of the alarms indicate that the A2 alarm is a root cause node of the alarm. As a result, the fourth exemplary alarm event yields a single ticketable event. This is a result from the receipt of the alarm A2 (i.e., A2 key) from a Type A network element that is part of SG1 and SG2, followed by the alarms A1, B1, C1, D1 and E1 from their respective network elements in service groups SG1, SG2, and SG3. The hierarchical arrangement depicted in FIG. 2F illustrates the relationship that is determined, showing the A2 alarm (with the A2 key) as the root cause alarm for the A1, the B1, the C1, the D1 and the E1 alarms.

In various embodiments, the ticketing system 204 issues a ticket for a fault correction action with respect to the A2 alarm from a Type A network element in service groups SG1 and SG2, and for the rest of the alarms, a fault mitigation action and/or a fault prevention action will be taken. The single ticket with the A2 alarm as the root cause alarm will be sent to network maintenance technicians.

FIG. 2G depicts a fifth illustrative embodiment of determining a correlation and a root cause of network alarms in accordance with various aspects described herein. As depicted in FIG. 2D, a fifth exemplary alarm event takes places where at Time T0, an A1 alarm is received, at Time T1, a B1 alarm is received, at Time T2, a C1 alarm is received, at Time T3, a D1 alarm is received, at Time T4, an E1 alarm is received, and at Time T5, a C2 alarm is received. As depicted in FIG. 2G, the alarm management database 216 does not indicate a service group tag for the network element C2. Instead, the alarm management database 216 indicates a simple group tag for the network element C2, which belongs to Group C along with the C1 alarm. The C1 and C2 alarms belong to Group C, which indicate a Type C network element that is part of service groups SG2 and SG3. The fifth exemplary alarm event encompasses the situation where the C2 alarm is considered and treated as a Group C along with the C1 alarm, where the alarms C1 and C2 may be triggered by conditions that occur within a defined service group of Group C.

The alarm manager processes the fifth exemplary alarm event by accessing relevant information from the inventory database 215, the alarm management database 216, and the tracking table 217. The alarm management database 216 indicates that in the service groups SG1, SG2 and SG3, the A1 alarm is a parent alarm to the B1 alarm, when received prior to the B1 alarm, the parent alarm to the C1 alarm, which is a parent alarm to the D1 and E1 alarms. These relationship groups and the timing of the alarms indicate that the A1 alarm is a root cause node of the alarms B1, C1, C2, D1 and E1. As a result, the fifth exemplary alarm event yields a single ticketable event. This is a result from the receipt of the alarm A1 (i.e., A1 key), followed by alarms B1, C1, D1 and E1 from their respective network elements in service groups SG1, SG2, and SG3.Furthermore, the C2 alarm is triggered and follows the C1 alarm as the C1 alarm and the C2 alarm belong to the simple group tag, Group C. The hierarchical arrangement depicted in FIG. 2C illustrates the relationship that is determined, showing the A1 alarm (with the A1 key) as the root cause alarm for the alarms B1, C1, C2, D1, and E1.

In various embodiments, the ticketing system 204 issues a ticket for a fault correction action with respect to the alarm A1 and for the rest of the alarms (i.e., B1, C1, D1 and E1) in service groups SG1, SG2, and SG3 and the C2 alarm in Group C, a fault mitigation action and/or a fault prevention action will be taken. The single ticket with the A1 alarm (A1 key) as the root cause alarm will be sent to network maintenance technicians.

In various embodiments, the relationship groups described above used for alarm processing in a telecommunications or computer network of interconnected elements. Additionally, the relationship groups could be applied more generally to other forms of data from a set of related elements where there are relationships that can be defined at the element and data levels. Another possible use case could be in correlating performance data across multiple elements, e.g. to root cause a performance issue. To determine a root cause of performance issues, the relationship groups can be utilized such that a threshold alarm for performance compliance is set and an alarm is generated if one or more network elements fail to meet the threshold alarm. The relationship groups are analyzed in order to determine a root cause of the performance failure alarm. Alarms resulting from the interconnected network elements in the same relationship groups, in the same element type or both, may be triggered due to the root cause element and appropriate actions can be taken. As another example, CPU utilization levels of two associated network elements are analyzed and adjustment can be made to balance the CPU utilization levels, trigger an alarm or take an automatic action.

FIG. 2H depicts an illustrative embodiment of a method 220 in accordance with various aspects described herein. In various embodiments, the method 220 includes determining a topology of a group of network elements deployed in a communication network, where the network elements correspond to interconnected nodes within the group and have different network element types (Step 222); determining a relationship group associated with two or more of network element types at least based on the topology of the network elements and predetermined criteria (Step 223); establishing an alarm management database structured to correlate each alarm with each relationship group to which a network element type of each alarm belongs, via a relationship group tag and an alarm classification, wherein the alarm classification represents a hierarchical alarm level of each alarm in each relationship group correlated by the relationship group tag (Step 224); detecting a set of alarms from the group of network elements (Step 225); based on the correlated relationship group tag and the hierarchical alarm level, identifying one or more root cause nodes of the set of alarms, wherein the set of alarms has been originated from the one or more root cause nodes of the set of alarms (Step 226); and generating a fault correction ticket targeting the one or more root cause nodes of the set of alarms (Step 227).

In various embodiments, the method 220 further includes, based on the correlated relationship group tag and the hierarchical alarm level, determining that the set of alarms requires a single fault correction ticket targeting one root cause node of the set of alarms. The method 200 includes transmitting the single fault correction ticket identifying the root cause node to a network maintenance technician; and transmitting a fault mitigation request or a fault prevention request as to a rest of the set of alarms other than the root cause node. The determining the relationship group associated with two or more of the network element types further comprise determining one or more service groups associated with each alarm. The establishing of the alarm management database further includes establishing the alarm management database structured to correlate each alarm with each service group to which the network element type of each alarm belongs, via a service group tag and the alarm classification.

The method 200 further includes establishing an alarm signature definition database structured to store the service group tag assigned to each alarm; and the alarm classification, wherein the hierarchical alarm level represented by the alarm classification is a parent alarm or a child alarm as to alarms from one or more network element types in a same service group.

In various embodiments, the method 200 includes establishing a first database structured to store a service group tag associated with the two or more of the network element types and a second database structured to store a plurality of different alarm definitions resulting from each network element type in a form of an alarm key, wherein the alarm key indicates a unique alarm number within an alarm dictionary for an associated network element type and each alarm is identified by a unique alarm key.

In various embodiments, the method 200 includes creating the relationship group of the two or more network element types by using a template containing predetermined criteria, where the predetermined criteria includes a network element type, a service type, a region, or a combination thereof; and modifying the relationship group by using the template. The method 200 further includes removing the relationship group by using the template. The determining the root cause node of the set of alarms further include, in a first service group including a first network element type and a second network element type, determining that a first alarm triggered has the alarm classification as a parent alarm to a second alarm triggered in the first service group; in a second service group including the first network element type and a third network element type, determining that a third alarm triggered has the alarm classification as a child alarm to the first alarm; and identifying the first alarm as the root cause node with respect to the second alarm and the third alarm. The determining the root cause node of the set of alarms further includes, in a third service group including the third network element type and a fourth network element type, determining that a fourth alarm triggered has the alarm classification as a child alarm to the third alarm triggered; and identifying the first alarm as the root cause node with respect to the fourth alarm. The method 220 further includes determining, by the alarm manager, the set of alarms as a single ticketable event or multiple ticketable events.

FIG. 2I depicts an illustrative embodiment of a method 230 in accordance with various aspects described herein. In various embodiments, the method 230 includes detecting, by a processing system including a processor, a set of alarms from a plurality of network element types, where the plurality of network element types are interconnected via a particular topology and deployed in a communication network (Step 232); retrieving, by the processing system, each service group tag of the set of alarms, wherein a service group tag identifies two or more of the plurality of network element types that belong to a same service group (Step 233); determining, by the processing system, an alarm classification associated with the retrieved service group tag for each of the set of alarms (Step 234); identifying, by the processing system, a root cause alarm node based on the determined alarm classification (Step 235), and generating, by the processing system, a fault correction ticket for the identified root cause alarm node (Step 237).

In various embodiments, the method 230 includes, in a first service group having a first network element type and a second network element type, identifying, by the processing system, a first alarm for the first network element type as a parent alarm to a second alarm for the second network element type; in a second service group having the first network element type and a third network element type, identifying, by the processing system, the first alarm as the parent alarm to a third alarm for the third network element type; and generating, by the processing system, a single fault correction ticket for the first alarm, where the set of alarms comprises the first alarm, the second alarm and the third alarm.

In various embodiments, the method 230 includes, in a first service group having a first network element type and a second network element type, identifying, by the processing system, a first alarm for the first network element type as a child alarm to a second alarm for the second network element type; in a second service group having the first network element type and a third network element type, identifying, by the processing system, the first alarm as a child alarm to a third alarm for the third network element type; and generating, by the processing system, two fault correction tickets for the second alarm and the third alarm, where the set of alarms comprises the first alarm, the second alarm and the third alarm.

In various embodiments, the method 230 further includes detecting, by the processing system, a compute alarm, where the detecting the set of alarms further comprises detecting the set of alarms subsequent to the detecting of the compute alarm; identifying, by the processing system, the compute alarm as the root cause alarm node; and generating, by the processing system, a single fault correction ticket for the compute alarm. The method 230 further includes detecting, by the processing system, a target alarm prior to the detection of the set of alarms, where the target alarm is not associated with the set of alarms by a service group tag and the target alarm is associated with one of the set of alarms by a simple group tag; determining, by the processing system, that the alarm classification of the one of the set of alarms by the simple group tag is a parent alarm; determining, by the processing system, that the target alarm is a root cause alarm node; and generating, by the processing system, a single fault ticket with respect to the target alarm.

In various embodiments, the method 230 further includes detecting, by the processing system, a target alarm subsequent to the detection of the set of alarms, wherein the target alarm is not associated with the set of alarms by a service group tag and the target alarm is associated with one of the set of alarms by a simple group tag; determining, by the processing system, that the alarm classification of the one of the set of alarms by the simple group tag is a child alarm; and determining, by the processing system, that the target alarm is not a root cause alarm node.

In various embodiments, the method 230 further includes detecting, by the processing system, a target alarm prior to or subsequent to the detection of the set of alarms, where the target alarm is not associated with the set of alarms by a service group tag and the target alarm is associated with one of the set of alarms by a simple group tag; logging, by the processing system, the set of alarms in a first tracking table; logging, by the processing system, the target alarm in a second tracking table; and correlating occurrences of the set of alarms and the target alarm in the identifying of the root cause alarm node.

While for purposes of simplicity of explanation, the respective processes are shown and described as a series of blocks in FIGS. 2H-2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

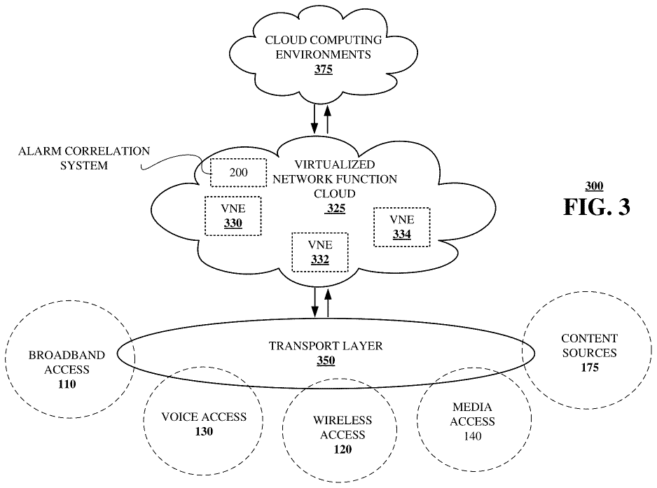

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 220, 230 presented in FIGS. 1, 2A, 2B, 2C through 2I, and 3. For example, virtualized communication network 300 can facilitate in whole or in part network alarm correlation systems and methods for use in communication networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

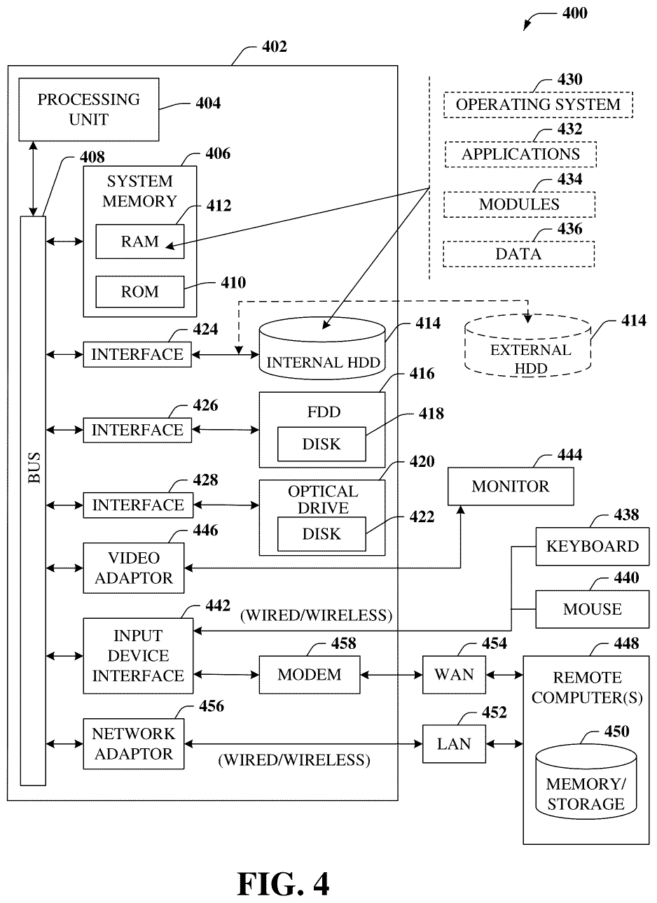

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part network alarm correlation systems and methods for use in communication networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

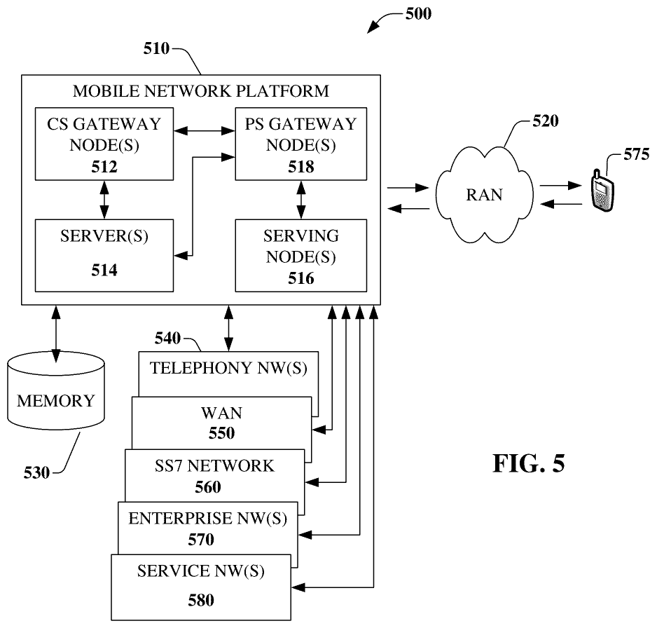

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part network alarm correlation systems and methods for use in communication networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

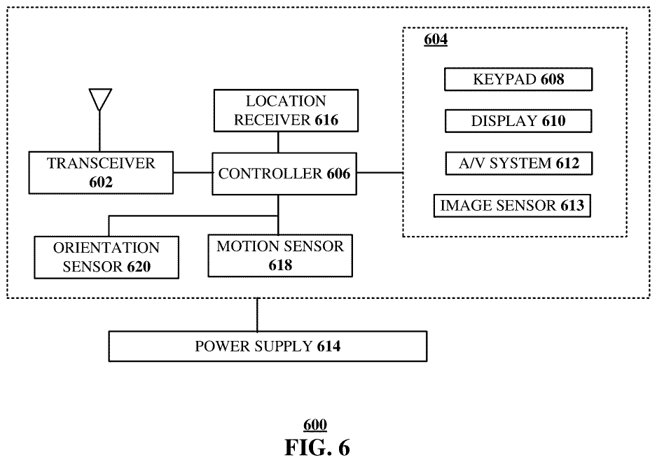

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part network alarm correlation systems and methods for use in communication networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
determining a topology of a group of network elements deployed in a communication network, wherein the network elements correspond to interconnected nodes within the group and have different network element types;
determining a relationship group associated with two or more of network element types at least based on the topology of the network elements and predetermined criteria;
establishing an alarm management database structured to correlate each alarm with each relationship group to which a network element type of each alarm belongs, via a relationship group tag and an alarm classification, wherein the alarm classification represents a hierarchical alarm level of each alarm in each relationship group correlated by the relationship group tag;
detecting a set of alarms from the group of network elements;
based on the correlated relationship group tag and the hierarchical alarm level, identifying one or more root cause nodes of the set of alarms, wherein the set of alarms has been originated from the one or more root cause nodes of the set of alarms; and
generating a fault correction ticket targeting the one or more root cause nodes of the set of alarms.

2. The device of claim 1, wherein the operations further comprise, based on the correlated relationship group tag and the hierarchical alarm level, determining that the set of alarms requires a single fault correction ticket targeting one root cause node of the set of alarms.

3. The device of claim 2, wherein the operations further comprise:
transmitting the single fault correction ticket identifying the one root cause node to a network maintenance technician; and
transmitting a fault mitigation request or a fault prevention request as to a rest of the set of alarms other than the one root cause node.

4. The device of claim 1, wherein the determining the relationship group associated with two or more of the network element types further comprise determining one or more service groups associated with each alarm.

5. The device of claim 4, wherein the establishing of the alarm management database further comprises establishing the alarm management database structured to correlate each alarm with each service group to which the network element type of each alarm belongs, via a service group tag and the alarm classification.

6. The device of claim 5, wherein the operations further comprise establishing an alarm signature definition database structured to store:
the service group tag assigned to each alarm; and
the alarm classification, wherein the hierarchical alarm level represented by the alarm classification is a parent alarm or a child alarm as to alarms from one or more network element types in a same service group.

7. The device of claim 1, wherein the operations further comprise:
establishing a first database structured to store a service group tag associated with the two or more of the network element types and a second database structured to store a plurality of different alarm definitions resulting from each network element type in a form of an alarm key, wherein the alarm key indicates a unique alarm number within an alarm dictionary for an associated network element type and each alarm is identified by a unique alarm key.

8. A non-transitory machine-readable medium, comprising executable instructions that, when executed by a processing system including a processor, facilitate performance of operations, the operations comprising:
maintaining a service group database structured to store a service group tag indicating a relationship group of two or more network element types;
maintaining an alarm definition database structured to store a plurality of different alarm definitions resulting from each network element type in a form of an alarm key, wherein a unique alarm key identifies each alarm in the plurality of different alarm definitions;
maintaining an alarm management database structured to link each alarm with each relationship group to which a network element type of each alarm belongs, via the service group tag and an alarm classification, wherein the alarm classification represents a hierarchical alarm level of each alarm in each relationship group linked by the service group tag;
receiving a set of alarms resulting from a target group having different network element types interconnected via a particular topology within the target group, wherein the set of alarms is generated sequentially or simultaneously;
executing an alarm manager to determine a root cause node of the set of alarms using the service group tag and the alarm classification of each alarm in the alarm management database within the target group; and
generating a ticket responsive to the determined root cause node of the set of alarms.

9. The non-transitory machine-readable medium of claim 8, wherein the operations further comprise:
creating the relationship group of the two or more network element types by using a template containing predetermined criteria, wherein the predetermined criteria includes a network element type, a service type, a region, or a combination thereof; and
modifying the relationship group by using the template.

10. The non-transitory machine-readable medium of claim 9, wherein the operations further comprise removing the relationship group by using the template.

11. The non-transitory machine-readable medium of claim 8, wherein the determining the root cause node of the set of alarms further comprise:
in a first service group including a first network element type and a second network element type, determining that a first alarm triggered has the alarm classification as a parent alarm to a second alarm triggered in the first service group; and
in a second service group including the first network element type and a third network element type, determining that a third alarm triggered has the alarm classification as a child alarm to the first alarm; and
identifying the first alarm as the root cause node with respect to the second alarm and the third alarm.

12. The non-transitory machine-readable medium of claim 11, wherein the determining the root cause node of the set of alarms further comprise:
in a third service group including the third network element type and a fourth network element type, determining that a fourth alarm triggered has the alarm classification as a child alarm to the third alarm triggered; and
identifying the first alarm as the root cause node with respect to the fourth alarm.

13. The non-transitory machine-readable medium of claim 12, wherein the operations further comprise determining, by the alarm manager, the set of alarms as a single ticketable event.

14. A method, comprising:
detecting, by a processing system including a processor, a set of alarms from a plurality of network element types, wherein the plurality of network element types are interconnected via a particular topology and deployed in a communication network;
retrieving, by the processing system, each service group tag of the set of alarms, wherein a service group tag identifies two or more of the plurality of network element types that belong to a same service group;
determining, by the processing system, an alarm classification associated with the retrieved service group tag for each of the set of alarms;
identifying, by the processing system, a root cause alarm node based on the determined alarm classification; and
generating, by the processing system, a fault correction ticket for the identified root cause alarm node.

15. The method of claim 14, further comprising:
in a first service group having a first network element type and a second network element type, identifying, by the processing system, a first alarm for the first network element type as a parent alarm to a second alarm for the second network element type;
in a second service group having the first network element type and a third network element type, identifying, by the processing system, the first alarm as the parent alarm to a third alarm for the third network element type; and
generating, by the processing system, a single fault correction ticket for the first alarm, wherein the set of alarms comprises the first alarm, the second alarm and the third alarm.

16. The method of claim 14, further comprising:
in a first service group having a first network element type and a second network element type, identifying, by the processing system, a first alarm for the first network element type as a child alarm to a second alarm for the second network element type;
in a second service group having the first network element type and a third network element type, identifying, by the processing system, the first alarm as a child alarm to a third alarm for the third network element type; and
generating, by the processing system, two fault correction tickets for the second alarm and the third alarm, wherein the set of alarms comprises the first alarm, the second alarm and the third alarm.

17. The method of claim 14, comprising:
detecting, by the processing system, a compute alarm;
wherein the detecting the set of alarms further comprises detecting the set of alarms subsequent to the detecting of the compute alarm;
identifying, by the processing system, the compute alarm as the root cause alarm node; and
generating, by the processing system, a single fault correction ticket for the compute alarm.

18. The method of claim 14, comprising:
detecting, by the processing system, a target alarm prior to the detection of the set of alarms, wherein the target alarm is not associated with the set of alarms by a service group tag and the target alarm is associated with one of the set of alarms by a simple group tag;
determining, by the processing system, that the alarm classification of the one of the set of alarms by the simple group tag is a parent alarm;
determining, by the processing system, that the target alarm is a root cause alarm node; and
generating, by the processing system, a single fault ticket with respect to the target alarm.

19. The method of claim 14, comprising:
detecting, by the processing system, a target alarm subsequent to the detection of the set of alarms, wherein the target alarm is not associated with the set of alarms by a service group tag and the target alarm is associated with one of the set of alarms by a simple group tag;
determining, by the processing system, that the alarm classification of the one of the set of alarms by the simple group tag is a child alarm; and
determining, by the processing system, that the target alarm is not a root cause alarm node.

20. The method of claim 14, further comprising:
detecting, by the processing system, a target alarm prior to or subsequent to the detection of the set of alarms, wherein the target alarm is not associated with the set of alarms by a service group tag and the target alarm is associated with one of the set of alarms by a simple group tag;
logging, by the processing system, the set of alarms in a first tracking table;
logging, by the processing system, the target alarm in a second tracking table; and
correlating occurrences of the set of alarms and the target alarm in the identifying of the root cause alarm node.
